(19) United States
(12) Patent Application Publication
(10) Pub. No.: US 2017/0104737 A1
(43) Pub. Date: Apr. 13, 2017

(54) USER ACCOUNT MANAGEMENT FLOW IN SERVICE ENVIRONMENT

(71) Applicant: MICROSOFT TECHNOLOGY LICENSING, LLC, Redmond, WA (US)

(72) Inventors: Ankit Choudhari, Bothell, WA (US); Dina So, Bothell, WA (US)

(73) Assignee: MICROSOFT TECHNOLOGY LICENSING, LLC, Redmond, WA (US)

(21) Appl. No.: 15/274,399

(22) Filed: Sep. 23, 2016

Related U.S. Application Data
(60) Provisional application No. 62/240,210, filed on Oct. 12, 2015.

(51) Int. Cl. H04L 29/06; H04L 29/08

(52) U.S. Cl. CPC H04L 63/062; H04L 67/306; H04L 67/10; H04L 67/26; H04L 63/083; H04L 63/18; H04L 63/102

(57) ABSTRACT

Management of user profiles in a cloud-based service environment is provided. Upon completion of a profile change such as password change, password creation, or account deletion for a user, an administrator (or user with administrator privileges) may be presented with an option to provide the changed or created password, or other information directly to the user through messaging, thus, avoiding a multi-layered and/or manual process of the administrator copying the information to a message and sending to the user. The message may be text message, audio message, or video message.

### CROSS-REFERENCE TO RELATED APPLICATION

This application claims priority under 35 U.S.C. §119 of U.S. Patent Provisional Application No. 62/240,210 filed on Oct. 14, 2015. The U.S. patent application is herein incorporated by reference in its entirety.

### BACKGROUND

With the proliferation of networking and computing devices, cloud-based services are increasingly replacing locally installed applications. Many functionalities such as productivity, data analysis, scheduling, communications, and comparable ones are provided by cloud-based services. Administration of such services is also increasingly simplified and made user-friendly. While expert administrator handling was required for conventional systems, “lay” administrators or regular users with sufficient credentials may be enabled to perform an increasing number of administrative tasks such as adding new users, modifying user profiles or credentials.

For security purposes and traditional mechanisms of service management, many services involve multi-layer confirmation or authentication for changes performed by an administrator, which may result in degraded user experience.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to user account management flow in service environment. In some examples, a user with administrator privilege may be authentication and presented with an account management dashboard. Upon receiving a change to a profile of another user through the presented dashboard from the user with administrator privilege, a message notification may be transmitted to the other user via a selected communication mode such as a text message, a video message, or an audio message.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes an example network environment where a service with user account management flow may be implemented;

FIG. 2 illustrates conceptually user account management flow in service environment;

FIG. 3 illustrates example user interfaces for allowing a user with administrator privileges to select and modify user account settings;

FIG. 4 illustrates example user interfaces for allowing a user with administrator privileges to reset a user's password and inform the user about the reset via messaging;

FIG. 5 illustrates example user interfaces for allowing a user with administrator privileges to delete a user's account and inform the user about the deletion via messaging;

FIGS. 6A and 6B illustrate example user interfaces for informing a user about deletion of their service account and resetting of their service account password via messaging;

FIG. 7 is a networked environment, were a system according to embodiments may be implemented;

FIG. 8 is a block diagram of an example general purpose computing device, which may be used to provide user account management flow in service environment; and

FIG. 9 illustrates a logic flow diagram of a method to provide user account management flow in service environment.

### DETAILED DESCRIPTION

As briefly described above, embodiments are directed to management of user profiles in a cloud-based service environment. Upon completion of a profile change such as password change, password creation, or account deletion for a user, an administrator (or user with administrator privileges) may be presented with an option to provide the changed or created password, or other information directly to the user through messaging, thus, avoiding a multi-layered and/or manual process of the administrator copying the information to a message and sending to the user. The message may be text message, audio message, or video message.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based. or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing user account management flow in service environment. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

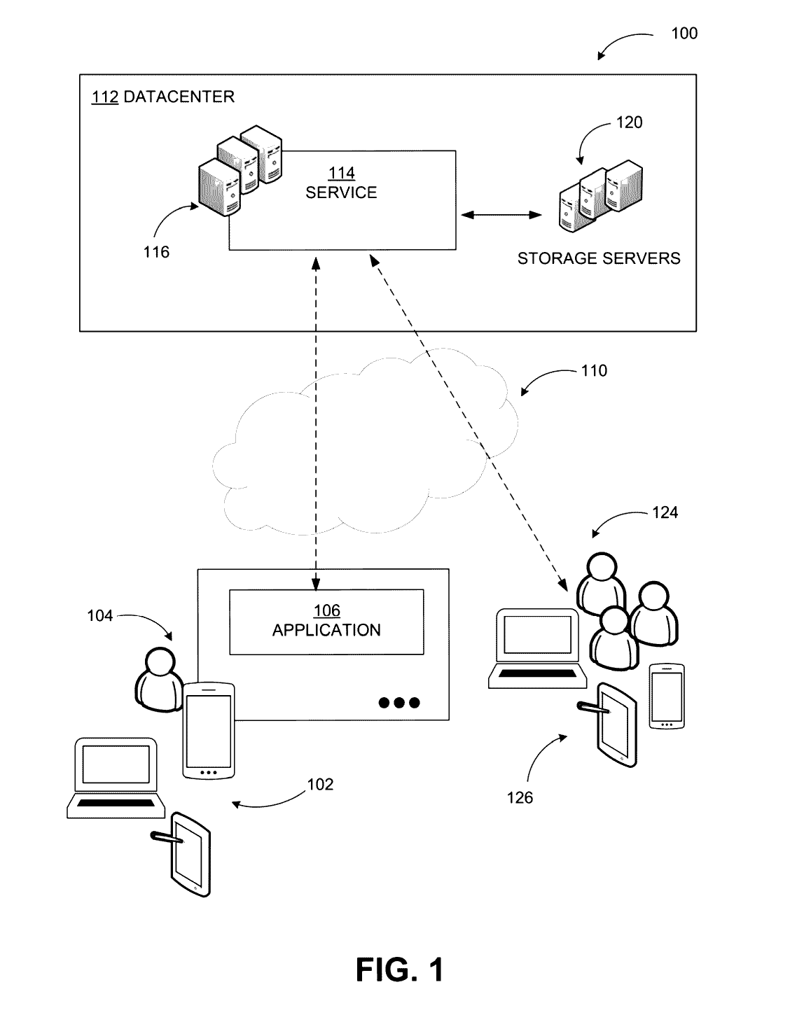

FIG. 1 includes an example network environment where a service with user account management flow may be implemented.

As illustrated in diagram 100, an example system may include a datacenter 112 hosting a cloud-based service 114 configured to provide a number of services such as productivity applications, collaboration applications, and others that may be accessed across multiple devices and users. The datacenter 112 may include one or more processing servers 116 configured to execute the service 114, among other components. In some embodiments, at least one of the processing servers 116 may be operable to manage the service 114, where data associated with the provided applications to and from devices (such as devices 122, 126) may be stored at storage servers 120 (or associated data stores). As described herein, the service 114 may be implemented as software, hardware, or combinations thereof.

In some embodiments, the service 114 may be configured to interoperate with various applications to provide the specific services. For example, as illustrated in the diagram 100, a user 104 may execute a thin (e.g., a web browser) or a thick (e.g., a locally installed client application) version of an application 106 through the device 102 with which the service 114 may be configured to integrate and interoperate with over one or more networks, such as network 110. The application 106 may be an application hosted by the service, such as a word processing application, a spreadsheet application, a communication application, a presentation application, etc., for example. The device 102 may include a desktop computer, a laptop computer, a tablet computer, a vehicle mount computer, a smart phone, or a wearable computing device, among other similar devices. A communication interface may facilitate communication between the service 114 and the application 106 over the network 110.

The service 114 may be a subscription based service, that is, each user may have an account and access the services by logging in to their account using a password, for example. User credentials may need to be managed, passwords updated or reset, accounts deleted or added, and so on. Thus, one or more users with administrator privileges may be provided with tools such as a dashboard to access regular user accounts and make the changes. In some embodiments, a message notification may be transmitted to a user via a selected communication mode such as a text message, a video message, or an audio message to inform them about changes to their account.

The technical advantages of providing user management flow in a cloud-based service environment may include, among others, increased security and efficiency in user credential management (direct messaging instead of manual process), reduced processing and network bandwidth usage (use of text, audio, or video messaging to provide password changes, new passwords, account deletions), and improved user interaction by allowing users to receive faster, more secure, credential updates and continue their work without interruption.

Embodiments, as described herein, address a need that arises from very large scale of operations created by software-based services that cannot be managed by humans. The actions/operations described herein are not a mere use of a computer, but address results of a system that is a direct consequence of software used as a service offered in conjunction with large numbers of devices and users accessing subscription based services through accounts.

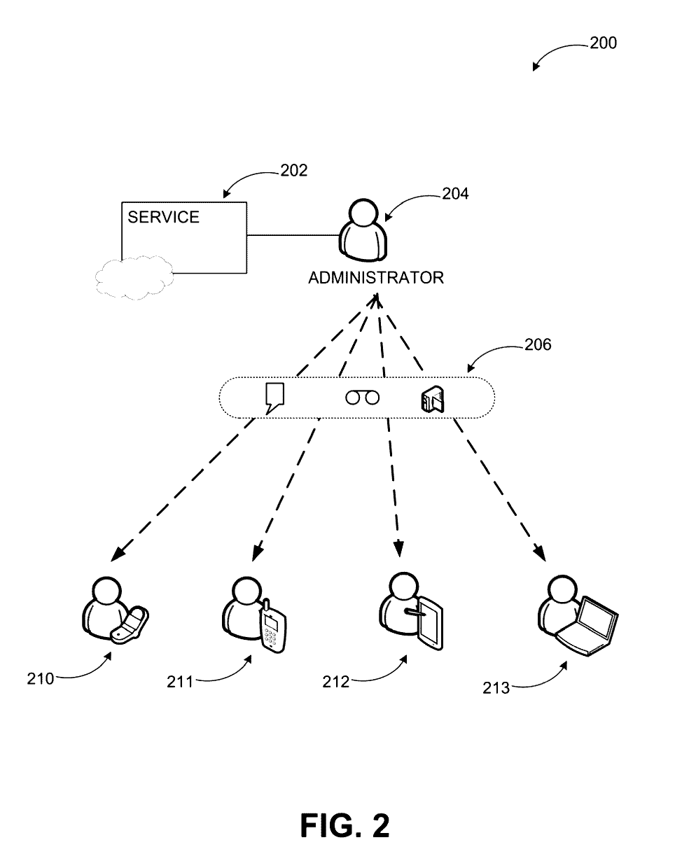

FIG. 2 illustrates conceptually user account management flow in service environment.

As shown in diagram 200, an administrator 204 of the service 202 may be enabled to manage user accounts through a separate application, a module, or an engine within the service 202 by accessing user account details through a dashboard or similar user interface. The administrator 204 may create new accounts, delete existing accounts, reset passwords, create new passwords, and perform comparable tasks for users 210-213, who may be subscribers of the service 202 and access the service 202 through various computing devices as shown in the diagram.

In conventional services, an administrator making changes to a user profile, for example, changing a user's password or creating a new password for a user, may access an email or other communication mechanism (e.g., phone call) and notify the user about the change. This may not be efficient and secure. In a system according to embodiments, the account management module or application may enable the administrator 204 to directly send the notification (e.g., the new password) to the affected user through text messaging, audio messaging, video messaging or similar direct communication mechanism 206 upon completing the change, thereby providing an efficient and secure mechanism to provide notification.

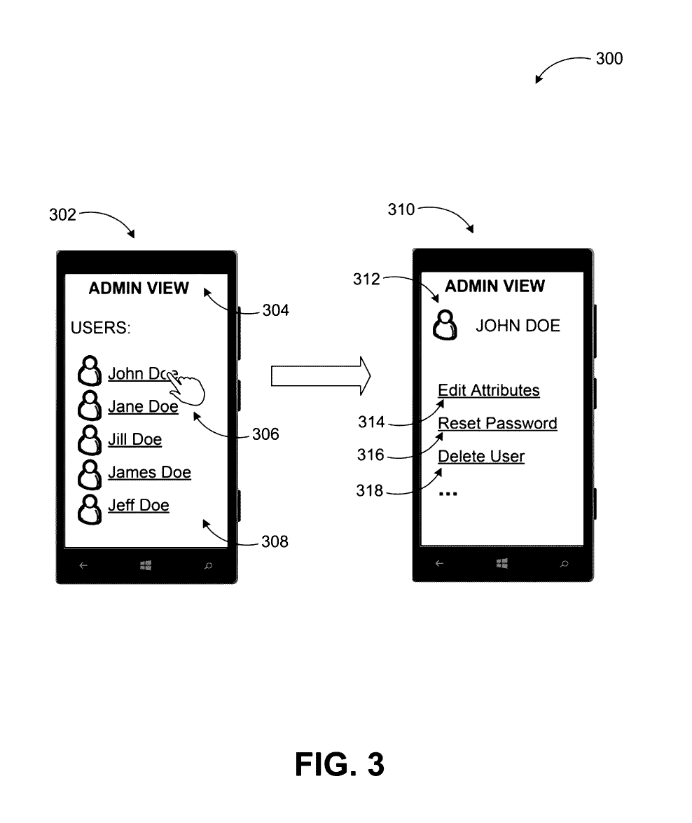

FIG. 3 illustrates example user interfaces for allowing a user with administrator privileges to select and modify user account settings.

An account management or administration module of a subscription based service may provide a dashboard or similar user interface to an administrator to enable the administrator to manage accounts of the subscribing users as shown in diagram 300. In the example user interface 302, the administrator view 304 is presented with a list of users 308 whose accounts may be managed by the administrator.

Upon selecting (306) one of the users, the administrator may be presented with a user interface 310 that provides specific functionality and options associated with the selected user 312. Example options may include editing of user attributes 314 (e.g., user address, identifier, phone number, permission levels, etc.), resetting of user password 316, and deleting user account 318. The options and functionalities displayed in the example user interface 310 are for illustration purposes and do not constitute a limitation on embodiments. Other options and functionality may be provided depending on service and account configurations. The options and functionality may be uniform for all users or customized based on user types.

Moreover, the example user interfaces in diagram 300 are shown on a mobile device. Account management user interfaces may be provided to be displayed on any suitable computing device including, but not limited to, mobile devices, tablet computers, desktop computers, and so on.

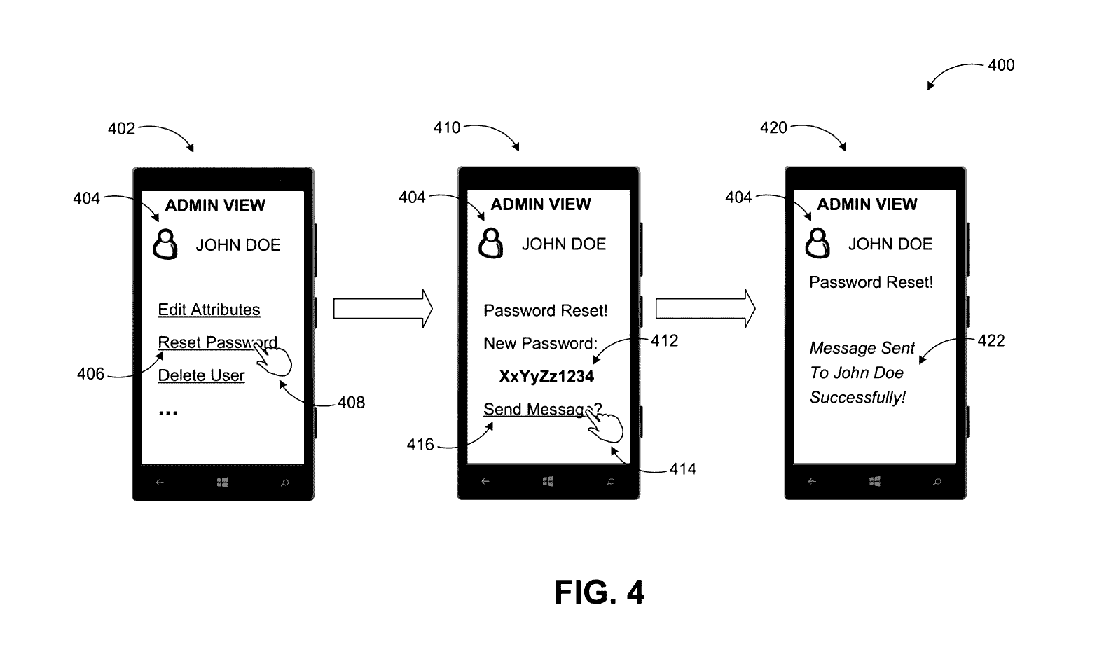

FIG. 4 illustrates example user interfaces for allowing a user with administrator privileges to reset a user's password and inform the user about the reset via messaging.

The flow of actions and corresponding user interfaces in diagram 400 begin with user interface 402 displaying to the administrator account management options for user 404. Upon selection 408 of resetting password action 406 by the administrator, user interface 410 may be displayed confirming that the password has been reset and optionally displaying the new password 412. In some examples, the password may not be displayed for security reasons. User interface 410 may also include an option to send a message 416 to the affected user.

Upon selection 414 of the send message 416 option, user interface 420 may be displayed confirming that the message about the new password has been sent to the user 422. The message may be a text message, an audio message, or a video message and include the new password, thereby avoiding a security risk by the administrator having to copy and paste the new password to another communication form such as an email. If the option is available, the transmitted message may be encrypted or similarly secured.

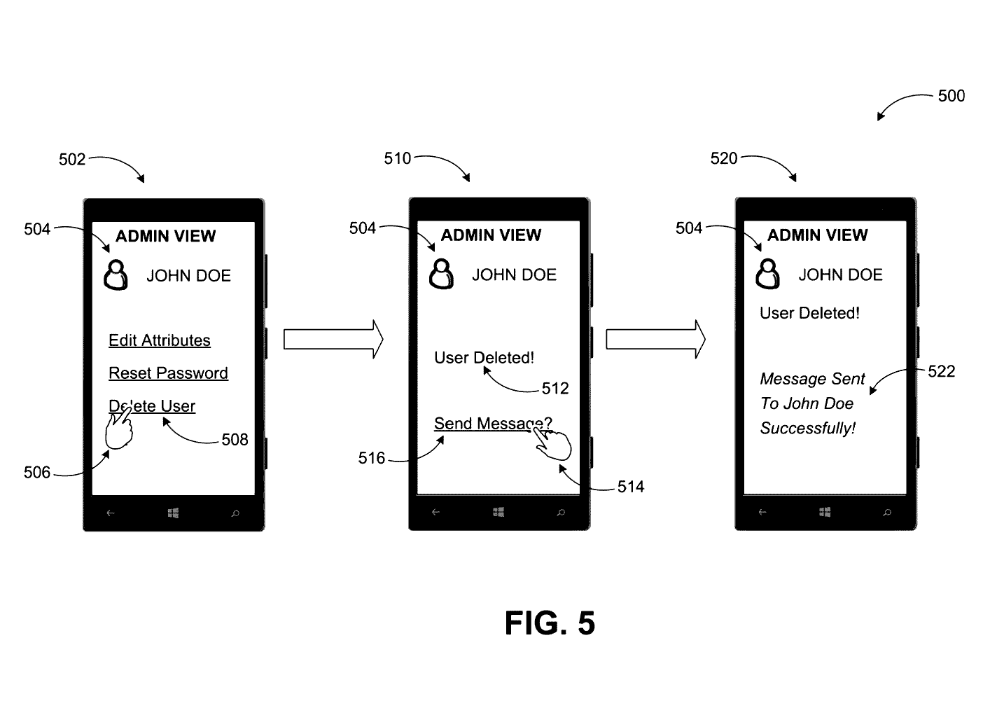

FIG. 5 illustrates example user interfaces for allowing a user with administrator privileges to delete a user's account and inform the user about the deletion via messaging.

The flow of actions and corresponding user interfaces in diagram 500 begin with user interface 502 displaying to the administrator account management options for user 504. Upon selection 506 of deleting user account action 508 by the administrator, user interface 510 may be displayed confirming that the user account has been deleted 512. User interface 510 may also include an option to send a message 516 to the affected user.

Upon selection 514 of the send message 516 option, user interface 520 may be displayed confirming that the message about the account deletion has been sent to the user 522. The message may be a text message, an audio message, or a video message and include the new password, thereby avoiding a security risk by the administrator having to copy and paste the new password to another communication form such as an email. If the option is available, the transmitted message may be encrypted or similarly secured.

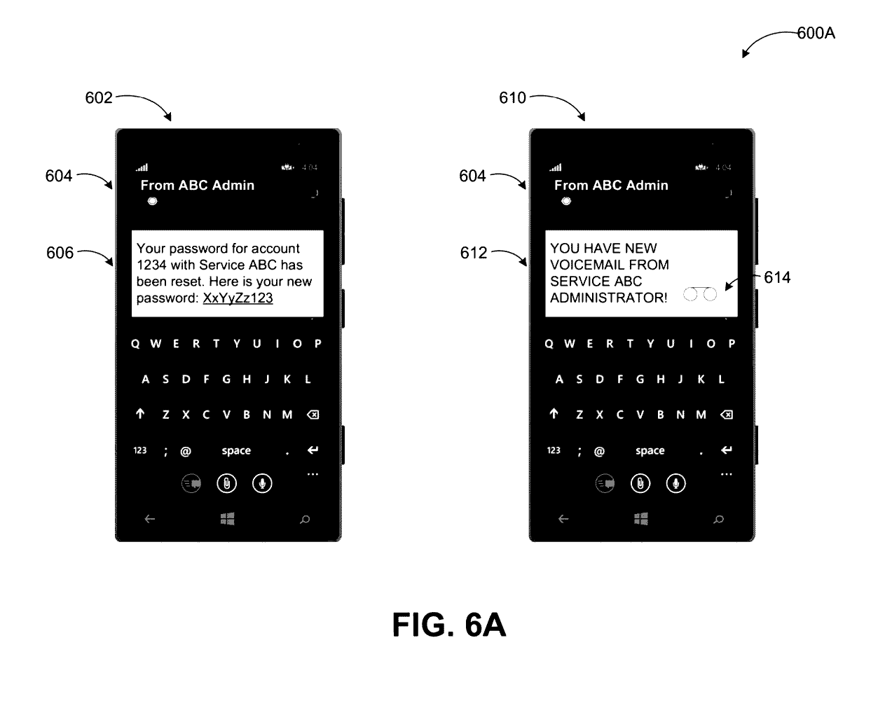

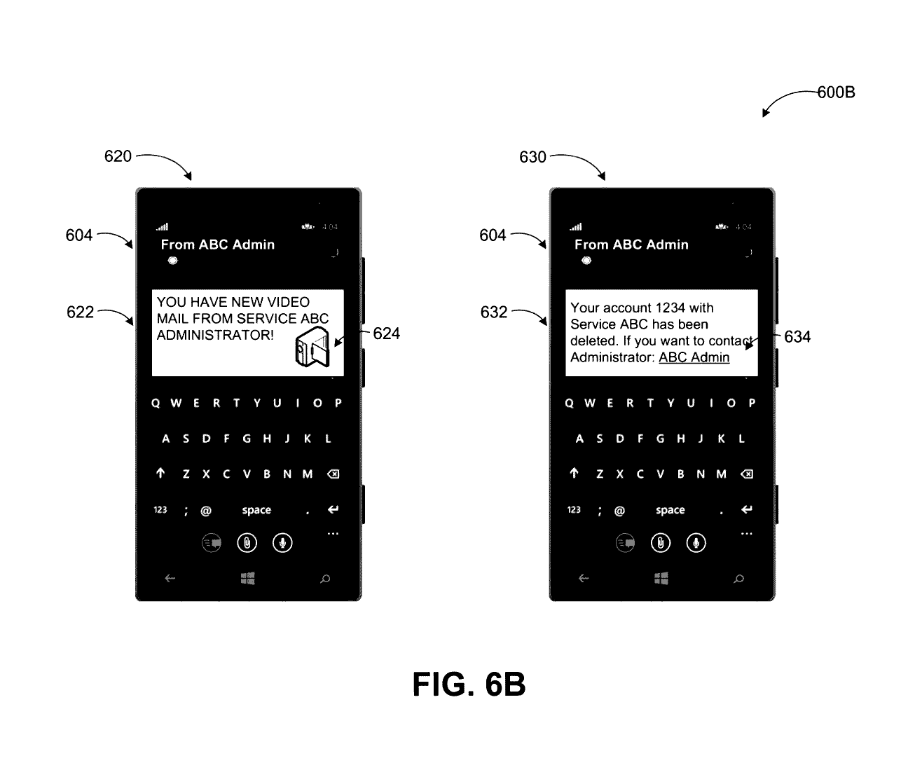

FIGS. 6A and 6B illustrate example user interfaces for informing a user about deletion of their service account and resetting of their service account password via messaging.

Diagram 600A shows two example user interfaces of a messaging application associated with a user of a service as described herein. User interface 602 includes a text message 606 from an administrator of service ABC (604). The message indicates that the user's password has been reset and also includes the new password. In some examples, the text message may be configured to be automatically deleted after a predefined period to avoid any security risks by preserving the message with the new password.

User interface 610 illustrates an alternative notification method. Message 612 on the user interface 610 may notify the user about an audio message (e.g., audio message link 614). The user may retrieve their new password by listening to the message. Similar to the text message option, the audio message may be configured to be automatically deleted after a predefined period to avoid any security risks by preserving the message with the new password.

Diagram 600B shows two further example user interfaces of a messaging application associated with a user of a service as described herein. User interface 620 includes a notification 622 to the user about a video message (e.g., video message link 624). The user may retrieve their new password by watching the video message. Similar to the text message option, the video message may be configured to be automatically deleted after a predefined period to avoid any security risks by preserving the message with the new password.

In some embodiments, different message options may be used each time a user's password is reset (randomly or according to a predefined pattern) to enhance security of the system.

User interface 630 includes a message 632 from the administrator of service ABC (604) notifying the user about deletion of their account with the service ABC corresponding to the example flow of actions in FIG. 5. The message may also include (optionally) a link 634 for the user to activate if they wish to contact the administrator or access an account management page about the deletion of their account.

The examples provided in FIGS. 1 through 6B are illustrated with specific systems, services, applications, modules, codes, and notifications. Embodiments are not limited to environments according to these examples. User account management flow in service environment may be implemented in environments employing fewer or additional systems, services, applications, engines, codes, and user experience configurations. Furthermore, the example systems, services, applications, modules, and notifications shown in FIG. 1 through 6B may be implemented in a similar manner with other values using the principles described herein.

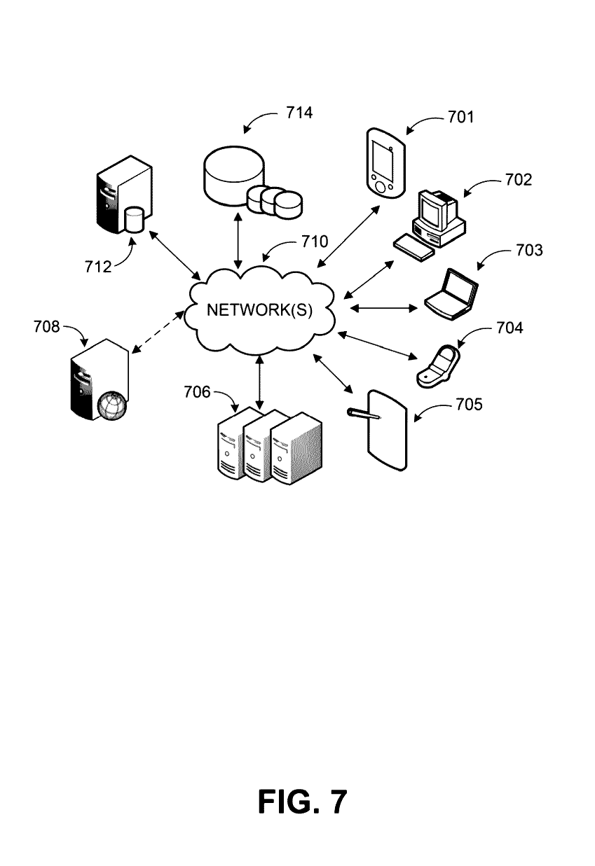

FIG. 7 is a networked environment, where a system according to embodiments may be implemented. In addition to locally installed applications (for example, application 107), user account management flow in service environment may also be employed in conjunction with hosted applications and services (for example, a service 114) that may be implemented via software executed over one or more servers 706, individual server 708, or at client devices, as illustrated in diagram 700. A hosted service or application may communicate with client applications on individual computing devices such as a handheld computer 701, a desktop computer 702, a laptop computer 703, a smart phone 704, a tablet computer (or slate), 705 (‘client devices’) through network(s) 710 and control a user interface presented to users.

Client devices 701-705 are used to access the functionality provided by the hosted service or application. One or more of the servers 706 or server 708 may be used to provide a variety of services as discussed above. Relevant data such as user data may be stored in one or more data stores (e.g. data store 714), which may be managed by any one of the servers 706 or by database server 712.

Network(s) 710 may comprise any topology of servers, clients, Internet service providers, and communication media. A system according to embodiments may have a static or dynamic topology. Network(s) 710 may include a secure network such as an enterprise network, an unsecure network such as a wireless open network, or the Internet, Network(s) 710 may also coordinate communication over other networks such as PSTN or cellular networks. Network(s) 710 provides communication between the nodes described herein. By way of example, and not limitation, network(s) 710 may include wireless media such as acoustic, RF, infrared and other wireless media.

Many other configurations of computing devices, applications, engines, data sources, and data distribution systems may be employed for user account management flow in service environment. Furthermore, the networked environments discussed in FIG. 7 are for illustration purposes only. Embodiments are not limited to the example applications, engines, or processes.

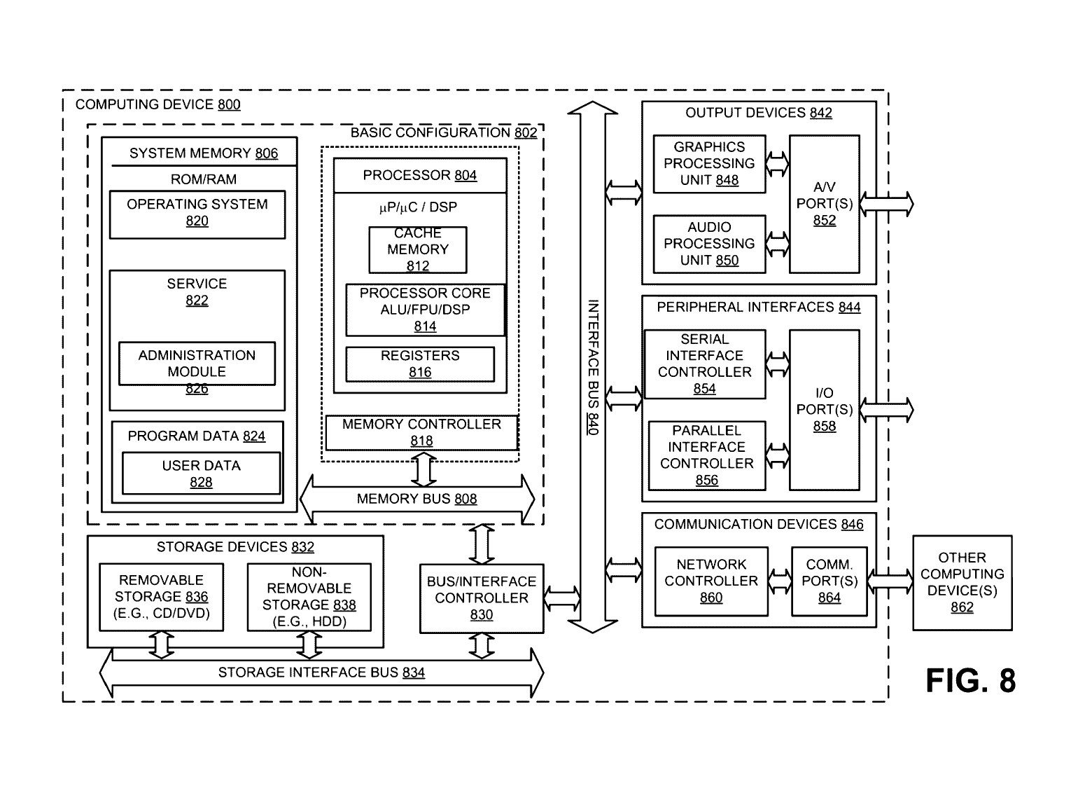

FIG. 8 is a block diagram of an example general purpose computing device, which may be used to provide user account management flow in service environment.

For example, computing device 800 may be used as a server, desktop computer, portable computer, smart phone, special purpose computer, or similar device. In an example basic configuration 802, the computing device 800 may include one or more processors 804 and a system memory 806. A memory bus 808 may be used for communicating between the processor 804 and the system memory 806. The basic configuration 802 is illustrated in FIG. 8 by those components within the inner dashed line.

Depending on the desired configuration, the processor 804 may be of any type, including but not limited to a microprocessor (μP), a microcontroller (μC), a digital signal processor (DSP), or any combination thereof. The processor 804 may include one more levels of caching, such as a level cache memory 812, one or more processor cores 814, and registers 816. The example processor cores 814 may (each) include an arithmetic logic unit (ALU), a floating point unit (FPU), a digital signal processing core (DSP Core), or any combination thereof. An example memory controller 818 may also be used with the processor 804, or in some implementations the memory controller 818 may be an internal part of the processor 804.

Depending on the desired configuration, the system memory 806 may be of any type including but not limited to volatile memory (such as RAM), non-volatile memory (such as ROM, flash memory, etc.) or any combination thereof. The system memory 806 may include an operating system 820, a service 822, and program data 824. The service 822 may include an administration module 826, which may manage user account settings and inform users via messages about password resets, account deletions, and the like. The program data 824 may include, among other data, user data 828, as described herein.

The computing device 800 may have additional features or functionality, and additional interfaces to facilitate communications between the basic configuration 802 and any desired devices and interfaces. For example, a bus/interface controller 830 may be used to facilitate communications between the basic configuration 802 and one or more data storage devices 832 via a storage interface bus 834. The data storage devices 832 may be one or more removable storage devices 836, one or more non-removable storage devices 838, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 806, the removable storage devices 836 and the non-removable storage devices 838 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 800. Any such computer storage media may be part of the computing device 800.

The computing device 800 may also include an interface bus 840 for facilitating communication from various interface devices (for example, one or more output devices 842, one or more peripheral interfaces 844, and al e or more communication devices 846) to the basic configuration 802 via the bus/interface controller 830. Some of the example output devices 842 include a graphics processing unit 848 and an audio processing unit 850, which may be configured to communicate to various external devices such as a display or speakers via one or more A/V ports 852. One or more example peripheral interfaces 844 may include a serial interface controller 854 or a parallel interface controller 856, which may be configured to communicate with external devices such as input devices (for example, keyboard, mouse, pen, voice input device, touch input device, etc.) or other peripheral devices (for example, printer, scanner, etc.) via one or more I/O ports 858. An example communication device 846 includes a network controller 860, which may be arranged to facilitate communications with one or more other computing devices 862 over a network communication link via one or more communication ports 864. The one or more other computing devices 862 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media, A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RE), microwave, infrared (IR) and other wireless media. The term computer readable media as used herein may include both storage media and communication media.

The computing device 800 may be implemented as a part of a general purpose or specialized server, mainframe, or similar computer that includes any of the above functions. The computing device 800 may also be implemented as a personal computer including both laptop computer and non-laptop computer configurations.

Example embodiments may also include methods to provide user account management flow in service environment. These methods can be implemented in any number of ways, including the structures described herein. One such way may be by machine operations, of devices of the type described in the present disclosure. Another optimal way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

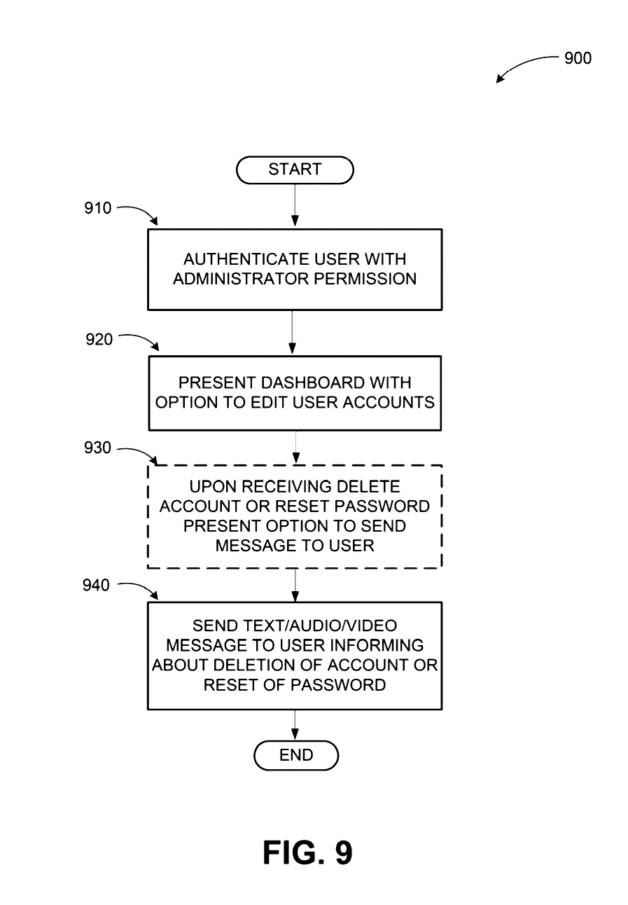

FIG. 9 illustrates a logic flow diagram of a method to provide user account management flow in service environment.

Process 900 may be implemented on a computing device, server, or other system. An example system may include a computer communicatively coupled to a cloud server hosting one or more components of a service including an administration module.

Process 900 begins with operation 910, where an administrator or a user with administrator privileges may be authenticated by the service. Upon successful authentication, the administrator may be presented with an account management user interface or dashboard that includes options to manage various aspects of a user's account.

At optional operation 930, the account management user interlace or dashboard may present the administrator with an option to send a message to the affected user upon receiving action(s) from the administrator such as deletion of a user account, resetting of a password, and similar ones. At operation 940, a message may be sent directly to the user from the system (that is, without the administrator having to create and send the message manually) informing the user about the change. The message may be a text message, an audio message, or a video message, and include a new password if the change is resetting of the password, for example.

The operations included in process 800 are for illustration purposes. User account management flow in service environment may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to examples, a means for providing user management flow in a cloud-based service environment is described. The means may include a means for authenticating a user with administrator privilege; a means for presenting an account management dashboard to the user; a means for receiving a change to a profile of another user through the presented dashboard; and a means for transmitting a message notification associated with the change to the other user via a selected communication mode.

According to some examples, a method executed at one or more computing devices to provide user management flow in a cloud-based service environment is described. The method may include authenticating a user with administrator privilege; presenting an account management dashboard to the user; receiving a change to a profile of another user through the presented dashboard; and transmitting a message notification associated with the change to the other user via a selected communication mode.

According to other examples, transmitting the message notification associated with the change may include transmitting one or more of a text message, an audio message, and a video message to the other user. The method may also include transmitting a different one of the text message, the audio message, and the video message in consecutive transmissions of the message notification to the other user. Transmitting the different one of the text message, the audio message, and the video message in consecutive transmissions of the message notification may include selecting the different one of the text message, the audio message, and the video message at random.

According to further examples, transmitting the different one of the text message, the audio message, and the video message in consecutive transmissions of the message notification may include selecting the different one of the text message, the audio message, and the video message according to a predefined pattern. The change to the profile may be a deletion of an account of the other user and the method may further include transmitting a confirmation of the deletion of the account in the message notification. The method may also include including a link to contact the user with the administrator privilege in the message notification. The change to the profile may be a reset of a password of the other user and the method may further include transmitting a confirmation of the reset of the password of the account in the message notification. The method may also include including a new password in the message notification.

According to other examples, a computing device to provide user management flow in a cloud-based service environment is described. The computing device may include a communication interface configured to facilitate communication between the computing device and a cloud based service; a memory configured to store instructions; and one or more processors coupled to the memory. The one or more processors, in conjunction with the instructions stored in the memory, may be configured to execute a cloud-based service. The cloud-based service may include one or more applications and an administration module. The administration module may be configured to authenticate a user with administrator privilege; present an account management dashboard to the user; receive a password reset for another user through the presented dashboard; and transmit one or more of a text message, an audio message, and a video message that includes a confirmation of the password reset and a new password to the other user.

According to some examples, the administration module may configure the one or more of the text message, the audio message, and the video message to be automatically deleted at a device of the other user after a predefined period. The administration module may also transmit a different one of the text message, the audio message, and the video message in consecutive transmissions to the other user based on one of a random selection and a predefined pattern. The administration module may further include information to contact the user with the administration privilege in the one or more of the text message, the audio message, and the video message. The administration module may also hide the new password in the presented account management dashboard, and/or transmit the one or more of the text message, the audio message, and the video message to two or more devices associated with the other user.

According to further examples, a method executed at one or more computing devices to provide user management flow in a productivity service is described. The method may include authenticating a user with administrator privilege at an administration module of the productivity service; presenting an account management dashboard to the user; receiving a password reset for another user through the presented dashboard; and transmitting one or more of a text message, an audio message, and a video message that includes a confirmation of the password reset and a new password to the other user.

According to yet other examples, the method may include transmitting the one or more of the text message, the audio message, and the video message through a messaging application within the productivity service. The method may further include transmitting the one or more of the text message, the audio message, and the video message through a messaging application separate from the productivity service. The method may also include receiving an account deletion for the other user through the presented dashboard; and including a confirmation of the account deletion for the other user in the one or more of the text message, the audio message, and the video message. The method may further include presenting the account management dashboard suitable for a mobile device environment.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at one or more computing devices to provide user management flow in a cloud-based service environment, the method comprising:
authenticating a user with administrator privilege;
presenting an account management dashboard to the user;
receiving a change to a profile of another user through the presented dashboard; and
transmitting a message notification associated with the change to the other user via a selected communication mode.

2. The method of claim 1, wherein transmitting the message notification associated with the change comprises:
transmitting one or more of a text message, an audio message, and a video message to the other user.

3. The method of claim 2, further comprising:
transmitting a different one of the text message, the audio message, and the video message in consecutive transmissions of the message notification to the other user.

4. The method of claim 3, wherein transmitting the different one of the text message, the audio message, and the video message in consecutive transmissions of the message notification comprise:
selecting the different one of the text message, the audio message, and the video message at random.

5. The method of claim 3, wherein transmitting the different one of the text message, the audio message, and the video message in consecutive transmissions of the message notification comprises:
selecting the different one of the text message, the audio message, and the video message according to a predefined pattern.

6. The method of claim 1, wherein the change to the profile is a deletion of an account of the other user and the method further comprises:
transmitting a confirmation of the deletion of the account in the message notification.

7. The method of claim 6, further comprising:
including a link to contact the user with the administrator privilege in the message notification.

8. The method of claim 1, wherein the change to the profile is a reset of a password of the other user and the method further comprises:
transmitting a confirmation of the reset of the password of the account in the message notification.

9. The method of claim 8, further comprising:
including a new password in the message notification.

10. A computing device to provide user management flow in a cloud-based service environment, the computing device comprising:
a communication interface configured to facilitate communication between the computing device and a cloud based service;
a memory configured to store instructions; and
one or more processors coupled to the memory, wherein the one or more processors, in conjunction with the instructions stored in the memory, are configured to execute a cloud-based service, the cloud-based service comprising;
one or more applications; and
an administration module configured to:
authenticate a user with administrator privilege;
present an account management dashboard to the user;
receive a password reset for another user through the presented dashboard; and
transmit one or more of a text message, an audio message, and a video message that includes a confirmation of the password reset and a new password to the other user.

11. The computing device of claim 10, wherein the administration module is further configured to:
configure the one or more of the text message, the audio message, and the video message to be automatically deleted at a device of the other user after a predefined period.

12. The computing device of claim 10, wherein the administration module is further configured to:
transmit a different one of the text message, the audio message, and the video message in consecutive transmissions to the other user based on one of a random selection and a predefined pattern.

13. The computing device of claim 10, wherein the administration module is further configured to:
include information to contact the user with the administration privilege in the one or more of the text message, the audio message, and the video message.

14. The computing device of claim 10, wherein the administration module is further configured to:
hide the new password in the presented account management dashboard.

15. The computing device of claim 10, wherein the administration module is further configured to:
transmit the one or more of the text message, the audio message, and the video message to two or more devices associated with the other user.

16. A method executed at one or more computing devices to provide user management flow in a productivity service, the method comprising:
authenticating a user with administrator privilege at an administration module of the productivity service;
presenting an account management dashboard to the user;
receiving a password reset for another user through the presented dashboard; and
transmitting one or more of a text message, an audio message, and a video message that includes a confirmation of the password reset and a new password to the other user.

17. The method of claim 16, further comprising:
transmitting the one or more of the text message, the audio message, and the video message through a messaging application within the productivity service.

18. The method of claim 16, further comprising;
transmitting the one or more of the text message, the audio message, and the video message through a messaging application separate from the productivity service.

19. The method of claim 16, further comprising:
receiving an account deletion fur the other user through the presented dashboard; and
including a confirmation of the account deletion for the other user in the one or more of the text message, the audio message, and the video message.

20. The method of claim 16, further comprising:
presenting the account management dashboard suitable for a mobile device environment.
